(19) United States
(12) Patent Application Publication
(10) Pub. No.: US 2003/0065766 A1
(43) Pub. Date: Apr. 3, 2003

(54) Geographic imaging device management

(76) Inventor: Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/967,576

(22) Filed: Sep. 28, 2001

(51) Int. Cl. G06F 15/173; G06F 15/16

(52) U.S. Cl. 709/224; 709/203

(57) ABSTRACT

Methods and systems for collecting imaging device usage information correlated with the physical location data of the imaging device generating such usage information are useful in managing imaging device systems. The physical location data may be collected from an imaging device along with the usage information by a management facility. Alternatively, the physical location data may be stored separate from the imaging device and associated with the imaging device's usage information by the management facility.

### TECHNICAL FIELD OF THE INVENTION

The present invention relates generally to imaging device management and in particular the present invention relates to geographic usage information gathering and management of imaging devices.

### BACKGROUND OF THE INVENTION

Imaging devices in organizations are typically implemented as networked printing and imaging service providers in computer networks. Many past and current imaging devices gather information on their use and operation within the network. Some of the commonly gathered usage information includes job origin, number of pages printed or imaged, number of copies of jobs received, number of errors, types of errors, marking material usage (such as ink, toner, thermal material, etc.), marking material level and consumables (such as paper, transparency, etc.) type and usage. In this disclosure imaging devices are intended to include, but are not limited to, printers, multi-function copiers, digital projectors, faxes, terminals, and other such imaging devices.

FIG. 1 details a simplified diagram of an imaging device system. FIG. 1 includes a network backplane 100, imaging devices 102 with imaging device usage information 104, a server 106, workstations 108, and a management facility 110. Each imaging device 102 gathers it own usage information 104. The management facility 110 is typically a software program running on some network device to allow management and querying of the imaging devices 102 across the network. Despite having a facility to allow querying and control of networked imaging devices, organizing and managing imaging device usage information in a manner meaningful to the administrator may be difficult, time consuming or inconvenient.

For the reasons stated above, and for other reasons stated below which will become apparent to those skilled in the art upon reading and understanding the present specification, there is a need in the art for a method of alternative methods of organizing and managing imaging device usage information.

### SUMMARY OF THE INVENTION

The above-mentioned problems with imaging device usage information gathering and other problems are addressed by the present invention and will be understood by reading and studying the following specification.

Methods and systems for collecting imaging device usage information correlated with the physical location data of the imaging device generating such usage information are useful in managing imaging device systems. The physical location data may be collected from an imaging device along with the usage information by a management facility. Alternatively, the physical location data may be stored separate from the imaging device and associated with the imaging device's usage information by the management facility.

For one embodiment, the invention provides a method of operating an imaging device system having one or more imaging devices. The method includes determining a physical location of at least one imaging device of the imaging device system, transmitting usage information from the at least one imaging devices to a management facility and correlating the usage information for the at least one imaging devices with data indicative of their physical locations using the management facility.

For another embodiment, the invention provides an imaging device system. The imaging device system includes a network, a management facility in association with the network and at least one imaging device in communication with the management facility. The management facility is adapted to collect usage information from each imaging device and to correlate the usage information with physical location data of the imaging devices.

For yet another embodiment, the invention provides a computer-usable medium having computer readable instructions stored thereon for execution by a processor to perform a method. The method includes collecting data from at least one imaging device, wherein the data includes at least usage information, and correlating the usage information from the at least one imaging device with physical location data of the at least one imaging device.

The invention further provides methods and apparatus of varying scope.

### BRIEF DESCRIPTION OF THE DRAWINGS

FIG. 1 is a simplified diagram of an imaging device system.

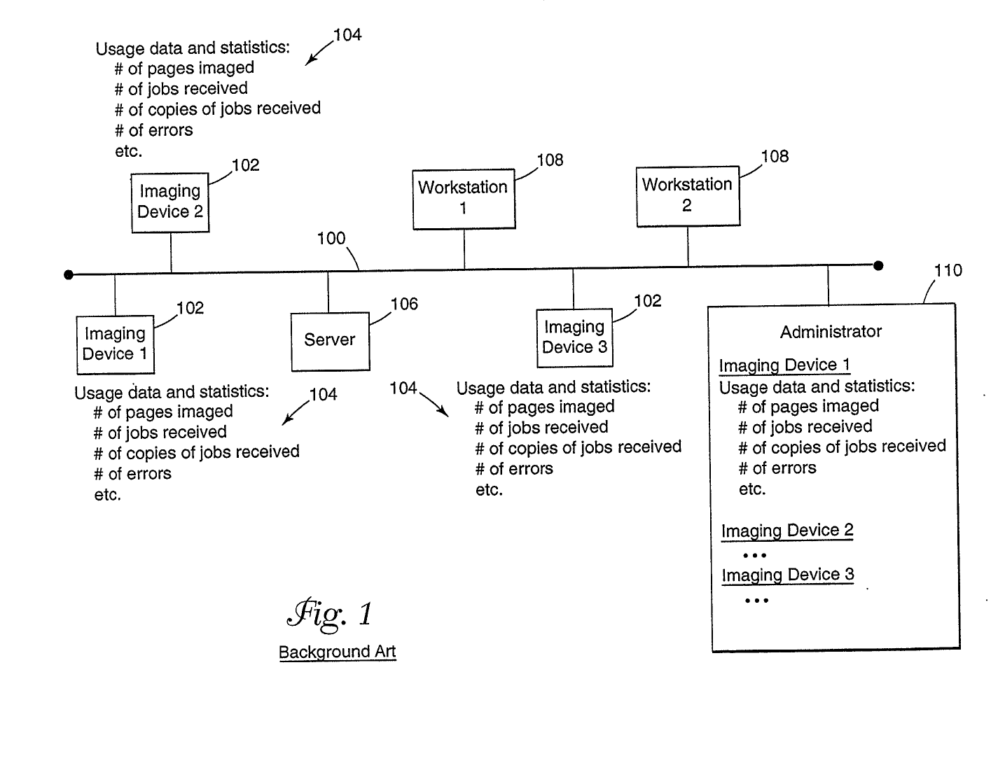

FIG. 2 is a simplified diagram of an imaging device system in accordance with an embodiment of the present invention.

FIGS. 3A-3D are flow charts for methods of data collection in accordance with embodiments of the invention.

FIG. 4 is a display showing imaging device physical location and usage information in accordance with an embodiment of the invention.

FIG. 5 is a network map showing imaging device physical location and usage information in accordance with another embodiment of the invention.

### DETAILED DESCRIPTION OF THE INVENTION

In the following detailed description of the preferred embodiments, reference is made to the accompanying drawings that form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and their equivalents.

Various embodiments of the present invention gather imaging device usage information associated with imaging device physical location information. This allows display and analysis of the imaging device information by geographical or physical location. It is noted that two or more imaging devices can share the same “location” for practical purposes if placed in close proximity, such as in the same room or area. Imaging device usage information is gathered by embodiments of the present invention across a network by a management facility. The management facility may be a function of a network device, such as a master imaging device, server, workstation or other similar device. The management facility is generally a software program running on some platform or operating system, but such functionality could be expressed in firmware or even hard-coded in a device such as an application-specific integrated circuit (ASIC) chip. In general, however, the management facility includes a set of computer-readable instructions stored on a computer-usable medium for execution by a processor. Examples of computer-usable medium include removable and non-removable magnetic media, optical media, dynamic random-access memory (DRAM), static random-access memory (SRAM), read-only memory (ROM) and electrically-erasable and programmable read-only memory (EEPROM or Flash).

Collection and storage of the location and usage information may be performed by the network device containing the management facility or by a separate network device under direction of the management facility. The usage information could contain, but is not limited to, job origin, the number of pages printed or imaged, the number of copies of jobs received, the types of jobs, the number of errors, the types of errors, marking material usage (such as ink, toner, thermal material, etc.), marking material level and consumables (such as paper, transparency, etc.) type and usage, and other usage information, statistics, or other consumables levels. It is noted that different imaging devices may collect differing usage information depending on imaging device model and configuration. For example, one networked imaging device may have only one media tray while another has multiple trays, or one networked imaging device may use toner while another uses ink and still another uses thermal imaging.

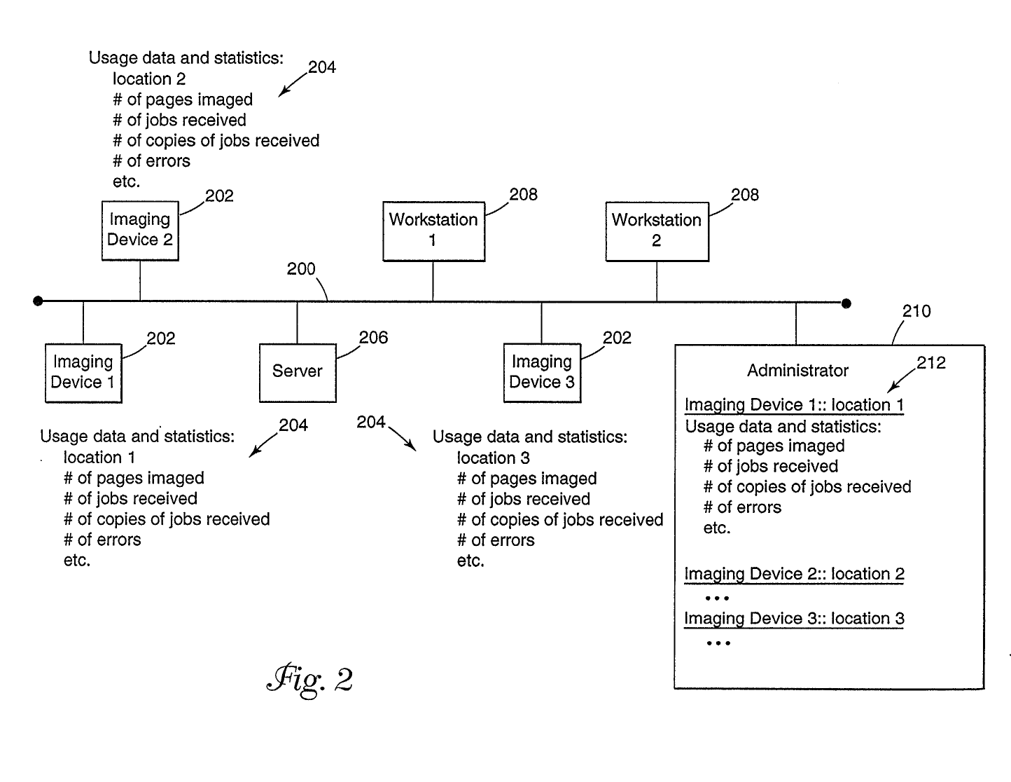

FIG. 2 details a simplified diagram of an imaging device system in accordance with an embodiment of the present invention. FIG. 2 includes a network back plane 200, imaging devices 202 with imaging device usage information 204, a server 206, workstations 208, and a management facility 210. Each imaging device 202 gathers it own usage information 204. Each imaging device 202 has a physical location 212. The management facility 210 allows management and querying of the imaging devices 202 across the network. Besides providing for management and querying the imaging devices 202, the management facility 210 in accordance with various embodiments of the invention generally collects the physical location data and usage information from and for the individual imaging devices 202 on an ongoing basis and can allow for collation, display, and analysis of the collected data. An example of a management facility 210 that allows for management of imaging devices 202 across a network and that can be adapted for this purpose includes the WEB JETADMIN™ printer management software program by Hewlett-Packard, Inc., Palo Alto, Calif., USA.

For embodiments of the present invention, the physical location data can either be input at the individual at the management facility. If the physical location data is input at the imaging device, the location data may be transferred between the imaging device and the management facility using a variety of communication protocols, some of which are described below.

When the physical location data is input via the management facility 210, the location data may optionally be transferred across the network to the individual imaging devices. While the location data is not required in both locations, transferring the location data to the imaging device can provide for decentralized verification that the location data entered in the management facility 210 matches the physical location 212 of the imaging device, e.g., the physical location data may be displayed at its associated imaging device for review by a user.

The physical location and usage information can be collected or distributed between the management facility 212 and the imaging devices 202 remotely across the network via a variety of communication protocols. Such protocols include, but are not limited to, simple network management protocol (SNMP), printer management language (PML), transmission control protocol/internet protocol (TCP/IP), and others.

Physical location data may be input by a user at the imaging device 202 with an input panel or other input device associated with the imaging device 202. The user may also input the physical location data at the imaging device 202 using an external input device. Examples of external input devices include imaging device management or audit tools. A user of the imaging device 202 can include end users of the imaging device 202 as well as other individuals using, monitoring or controlling the imaging device 202, such as administrators, technicians and service individuals.

Physical location data can also be remotely input across a network through the management facility 210. The physical location data may be input to the management facility in a variety of manners. Examples include keypad or keyboard entry of a numeric or textual representation of the physical location, as well as touchscreen entry against a graphical representation with relational spacing (e.g., a network graph) or other map image.

Additionally, the physical location of the imaging device 202 could be automatically determined without manual input. One example includes the use of global positioning systems (GPS). The GPS functionality could be incorporated into an imaging device 202. Using wireless networks, other methods of automatically determining a physical location of an imaging device 202 can be performed using device-to-device communications. Such methods are described in U.S. patent application Ser. No. (Atty Docket No. 10012344-1), entitled Locating and Mapping Wireless Network Devices via Wireless Gateways, which is commonly assigned. Examples of wireless networks that can be used with such methods include, but are not limited to, IEEE 802.11, BLUETOOTH™, and ultra wide band (UWB) networking.

Location data can also be input to the management facility 210 from an imaging device audit tool with which imaging device information and location data has been collected by an administrator or other user. For example, each imaging device 202 may include a barcode, a radio frequency (RF) tag or other machine-readable indicia identifying the imaging device 202 that could be scanned by a handheld audit tool. The location information may be entered manually into the handheld audit tool or scanned from a machine-readable indicia associated with, and indicative of, the physical location. Once gathered into the handheld audit tool, the location data could then be uploaded to the management facility 210.

Once the location data is input or otherwise determined, an imaging device location variable tag internal to the imaging device can be used to permanently store the location data. Alternatively, such storage can be provided at the management facility 210. Additional location data input manners should be apparent to those skilled in the art with the benefit of the present disclosure.

The method of collecting the physical location and usage information across a network can have multiple implementations. Generally speaking though, the imaging device location and usage information can be collected by a manually-triggered process, a polling or periodic process or an event-triggered process.

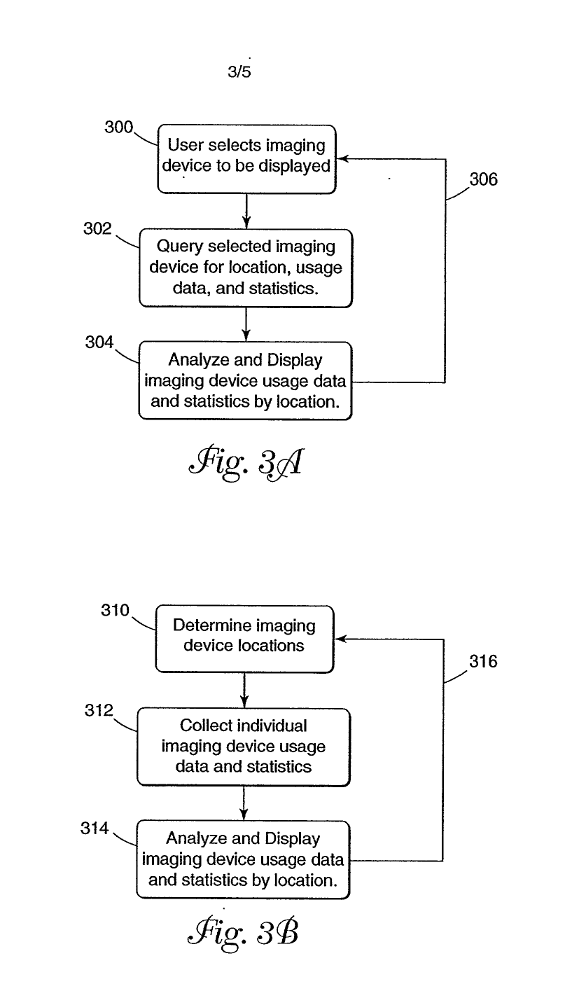

In a manually-triggered data collection process, the data gathering is manually triggered by the user. The information is therefore collected from the selected imaging devices by the management facility as directed by the user. The flowchart shown in FIG. 3A details a simplified manually triggered data collection event. In FIG. 3A, a user selects 300 the imaging device to be displayed, the selected imaging device is queried 302 for location and/or usage information, the received information is analyzed and displayed 304 by the management facility, and the management facility returns 306 to wait for the next user request. It is noted that since location data is generally unchanging relative to usage information, this location data can be collected during an initialization of the management facility and need not be re-collected from the imaging devices while in operation mode unless specifically requested by the user. Alternatively, the imaging device location information can be updated by an information update request sent from an imaging device that has been altered.

In a polled or periodic data collection process, the data is gathered on a periodic basis from the administered imaging devices and collected at the management facility for analysis and display. The flowchart shown in FIG. 3B details a simplified periodic process. In FIG. 3B, the imaging device locations are determined 310, the individual imaging device usage information is collected 312, and the collected information is analyzed and displayed 314 by location. At a predetermined time interval, the process loops and repeats 316. Differing imaging devices can have differing time intervals for data collection. As an example, it may be desirable to use a lower frequency of data collection on low-usage imaging devices.

A modified version of a periodic process is shown in FIG. 3C. As noted above, the imaging device location data is relatively unchanging. Therefore, in the polling process flowchart of FIG. 3C, the imaging device location data may be determined 320 upon start up, and the management facility from then on may loop, collecting 322 imaging device usage information and analyzing 324 the data for display.

In an event-triggered data collection process, the data gathering is triggered by some event, whether that event occurs at an imaging device or the management facility. Examples of events include the arrival of new location data or usage information from an imaging device, or some other interrupt. The flowchart shown in FIG. 3D details a simplified event-triggered process. In FIG. 3D, the management facility loops waiting for an event 330. While it is looping, other tasks can optionally be handled by the management facility if necessary. When an event or interrupt occurs 332, the individual imaging device usage and/or location data is collected 334 and stored 336 in the management facility for analysis and display. After the data collection, the management facility returns 330 to waiting for the next event.

The management facility can further collect data using some combination of two or more of the above-described methods. As one example, the management facility may collect data using both event-triggered and periodic processes such that it is collecting data periodically as well as in response to one or more events.

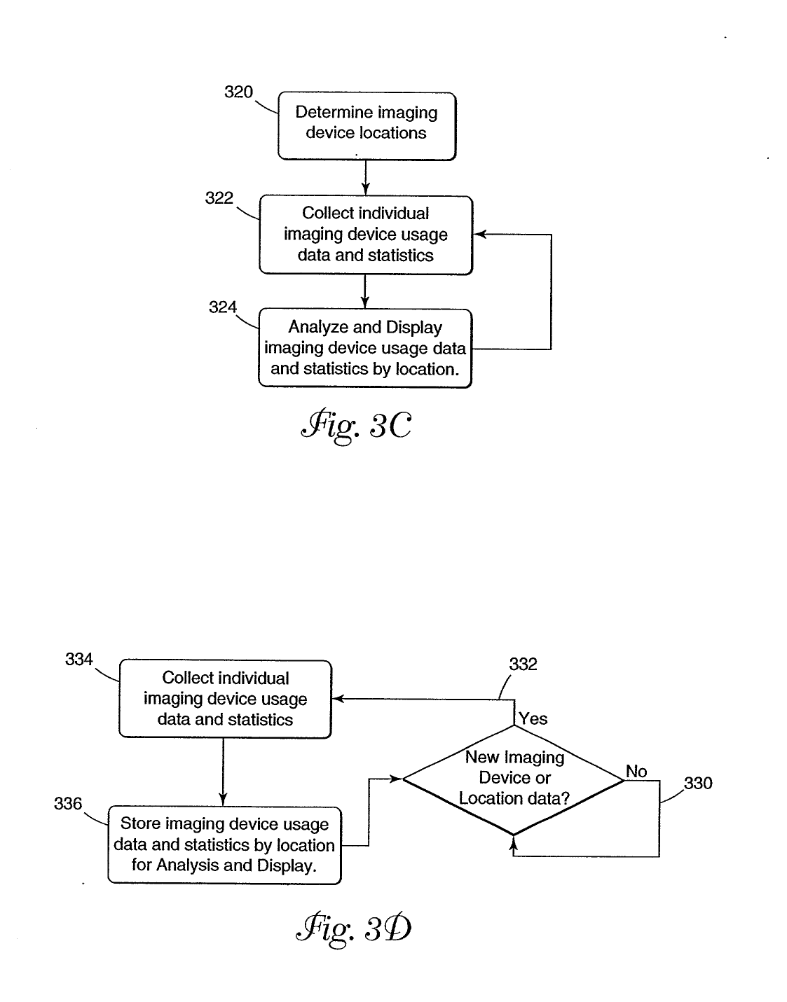

The gathered imaging device physical location information and usage information can be displayed to the user in many forms, including textual and graphical. An example of a graphical manner includes a bitmap representation of the physical location such as shown in FIG. 4. In FIG. 4, a simplified bitmap representation of an office space 400 is shown. The office space has four imaging devices, 402, 404, 406 and 408 that are represented in the bitmap. The selected imaging device 408 shows details of the imaging device and its usage information 410 by its location. Graphical representations such as shown in FIG. 4 can be drawn directly in the management facility, imported from other drawing program files, or interpolated from the imaging device physical location data.

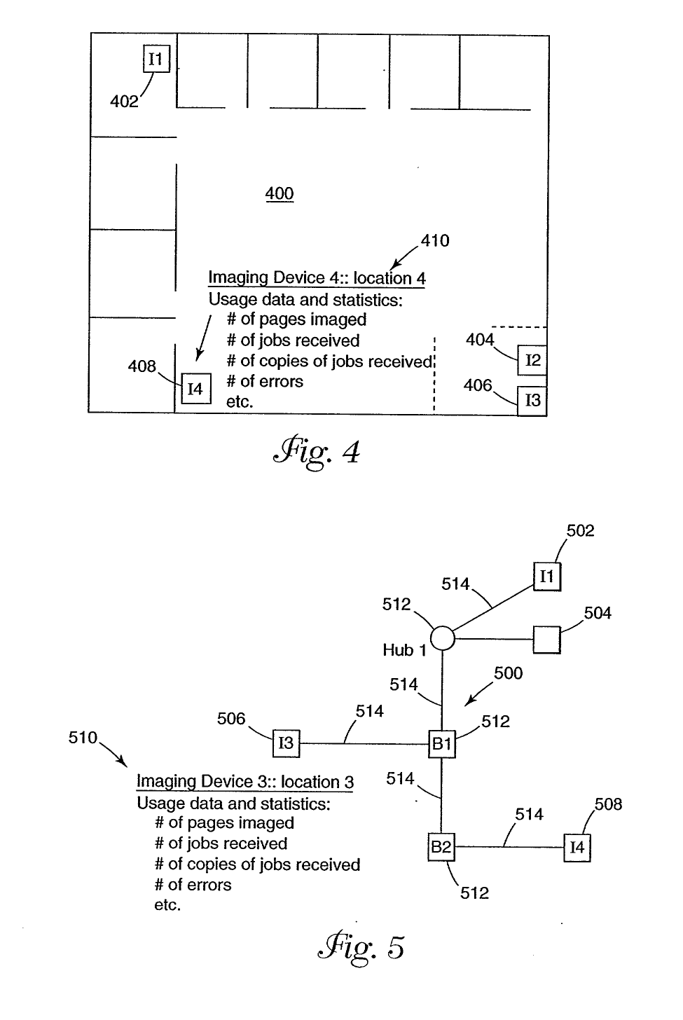

An alternative graphical display for gathered imaging device physical location information and usage information is a clickable map or network tree, as shown in FIG. 5. In FIG. 5, a network containing imaging devices is represented as a network tree 500 where nodes 512, leafs 502, 504, 506, and 508, and connections and branches 514 of the tree represent network devices and their interconnections. Four imaging devices, 502, 504, 506, and 508, are represented in the network tree 500 of FIG. 5. The selected imaging device 506 shows details of the imaging device, its physical location identifier, and its usage information 510 by its location. Imaging device location in the network tree 500 of FIG. 5 is thus displayed by network location and by physical location. As the usage information collected by the management facility is associated with a physical location of the imaging device generating the usage information, a user/administrator can correlate this information for display in a variety of other manners including tables, charts, graphs, spreadsheets and the like.

### Conclusion

Methods of collecting imaging device usage information correlated to the physical location of the imaging device have been detailed. Many networks and administrative systems allow querying and control of networked imaging device devices across the network by user and imaging device management software. However, it has been difficult to organize imaging device usage information by the physical location of the imaging devices. Lacking physical location data associated with the usage information, such correlation generally has been quite a user-intensive process and thus generally prohibitive. Methods in accordance with the invention collect imaging device usage information and correlate the usage information with physical location data to facilitate location-based analysis.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method, comprising:
determining a physical location of at least one imaging device in a network of imaging devices;
transmitting usage information from each of the at least one imaging devices to a management facility; and
correlating the usage information for each of the at least one imaging devices with data indicative of its physical location using the management facility.

2. The method of claim 1, further comprising:
presenting the correlated usage information to a user.

3. The method of claim 1, wherein transmitting the usage information further comprises transmitting the usage information using at least one process selected from the group consisting of a manually-triggered process, an event-triggered process and a periodic process.

4. The method of claim 1, wherein collecting the usage information further comprises collecting at least one usage datum selected from the group consisting of number of pages printed or imaged, number of jobs received, number of copies of jobs received, types of jobs, numbers of errors, the types of errors, marking material usage, marking material level, consumable type and consumable usage.

5. The method of claim 1, further comprising:
transmitting data indicative of the physical location of each of the at least one imaging devices to the management facility.

6. The method of claim 5, wherein transmitting data indicative of the physical location of each of the at least one imaging devices to the management facility occurs less frequently than transmitting usage information from each of the at least one imaging devices to the management facility.

7. The method of claim 1, wherein determining a physical location of at least one imaging device further comprises at least one imaging device determining its own physical location without manual input.

8. The method of claim 1, wherein at least two imaging devices of the imaging device system share the same physical location.

9. The method of claim 1, further comprising:
entering data indicative of the physical location of each of the imaging devices into a location selected from the group consisting of each imaging device, a network device containing the management facility, and a network device under the direction of the management facility.

10. An imaging device system comprising:
a network;
a management facility in association with the network; and
at least one imaging device in communication with the management facility;
wherein the management facility is adapted to collect usage information from each imaging device and to correlate the usage information with physical location data of the imaging devices.

11. The imaging device system of claim 10, wherein the management facility collects usage information and physical location data from each imaging device.

12. The imaging device system of claim 10, wherein the management facility collects usage information from each imaging device and associates the usage information with physical location data stored remotely from the imaging devices.

13. The imaging device system of claim 10, wherein the management facility collects usage information and physical location data from at least one of the imaging devices and wherein the management facility collects usage information from at least another one of the imaging devices and correlates that usage information with physical location data stored remotely from those imaging devices.

14. The imaging device system of claim 10, wherein at least one of the imaging devices has a global positioning system for determining its physical location.

15. A computer-usable medium having computer readable instructions stored thereon for execution by a processor to perform a method comprising:
collecting data from at least one imaging device, wherein the data includes at least usage information; and
correlating the usage information from the at least one imaging device with physical location data of the at least one imaging device.

16. The computer-usable medium of claim 15, wherein, in the method, collecting data from at least one imaging device further comprises collecting usage information and physical location data from the at least one imaging device.

17. The computer-usable medium of claim 15, wherein, in the method, collecting data from at least one imaging device further comprises collecting data using at least one process selected from the group consisting of a manually-triggered process, an event-triggered process and a periodic process.

18. The computer-usable medium of claim 17, wherein, in the method, collecting data from at least one imaging device further comprises collecting data using at least two of the processes selected from the group consisting of the manually-triggered process, the event-triggered process and the periodic process.

19. The computer-usable medium of claim 15, wherein the method further comprises:
displaying the correlated usage information.

20. The computer-usable medium of claim 15, wherein the method is adapted to correlate usage information with physical location even if two or more imaging devices share the same physical location.
